(19) United States
(12) Patent Application Publication
(10) Pub. No.: US 2010/0219564 A1
(43) Pub. Date: Sep. 2, 2010

(54) Resin Molding Apparatus and Resin Molding Process

(76) Inventor: Tadahiro Ohmi, Miyagi (JP)

Correspondence Address: FOLEY AND LARDNER LLP;SUITE 500, 3000 K STREET NW, WASHINGTON, DC, 20007, US

(21) Appl. No.: 11/991,800

(22) PCT Filed: Sep. 12, 2005
(86) PCT No.: PCT/JP2005/016734

§ 371 Date: Mar. 11, 2008

(51) Int. Cl. B29C 45/00; B29C 47/00; H05B 6/00

(52) U.S. Cl. 264/488; 425/543; 425/376.1; 264/176.1; 264/328.1

(57) ABSTRACT

Conventional production of plastic products not releasing harmful organic molecules requires a high injection or extrusion pressure in order to avoid heating of a resin to high temperature, resulting in use of a large-sized and heavy resin molding apparatus having high electric power consumption. The employment of a method of inhibiting oxidative decomposition and catalytic decomposition enables the formation of a molten plastic having an extremely low viscosity without decomposition or dissociation even at high temperature, whereby the molding of the resin can be conducted at a very low injection or extrusion pressure to attain the downsizing and weight saving of the resin molding apparatus.

### TECHNICAL FIELD

The present invention relates to a resin molding apparatus and a resin molding process, and more particularly, to an injection molding apparatus, a film extrusion molding apparatus, a fiber extrusion molding apparatus, and a molding process for the same.

### BACKGROUND ART

In molding a resin, it has been desired to produce plastic members, plastic films, and plastic fibers which do not emit any harmful organic molecules. Here, the harmful organic molecules generally refer to a low molecular weight component having a molecular weight of 1,000 or lower. This is because when the molecular weight reaches 1,000 or more, the harmful organic molecules are not emitted to the air due to a small vapor pressure. However, since the molecular weight increases as temperature increases, the molecular weight of the harmful low-molecular organic substance varies in accordance with the temperature increase. It has been expected to manufacture such a resin-molded product using a molding apparatus whose size, weight, and electric power consumption are reduced as much as possible.

In a conventional resin molding technique, a molten resin was treated at a given temperature at which a polymeric material did not change into a low-molecular organic substance due to decomposition and dissociation. Such a temperature was conventionally, for example, about 280° C. As a result, a clamping pressure as high as 1,500 t was required because the viscosity of a molten resin was high. Due to the necessity for bearing such a remarkably high pressure, the molding apparatus was large in size, weight, and electric power consumption. In order to reduce an injection pressure and a clamping pressure, the viscosity of a molten resin needed to be reduced. However, when the temperature of a resin was increased to about 280° C. or higher to attain that end, a polymeric resin decomposed and dissociated in a conventional molding apparatus.

For example, recent resin optical members have been more reduced in thickness, increased in size, and becoming finer in surface shape. In order to form a calculated optical shape in the resin molding apparatus, it has become necessary to reduce the viscosity of a molten resin to ensure fluidity of the molten resin.

### DISCLOSURE OF THE INVENTION

### Problem to be Solved by the Invention

As a process of reducing the melting viscosity of a resin, there is a process of changing the property of the resin itself, but a process of easily reducing the viscosity of the resin material is to raise the temperature during melting. However, raising the melting temperature of the resin causes decomposition and degradation of the resin as described above. Transparency of an optical member is important. In the resin molding process, a resin to be molten by heating becomes more likely to be decomposed and degraded as the temperature of the resin rises. Further, when oxygen exists during high-temperature melting, the molten resin reacts with the oxygen to be easily oxidatively degraded. Normally, the oxidative degradation temperature of a resin is lower than the decomposition degradation temperature thereof in an oxidization-free atmosphere. The oxidatively degraded resin is subjected to coloring and a change in refractive index. Such a resin remains in a molded product as it is and becomes a contaminant to reduce the transparency of the resin and cause quality degradation of the resin. Further, a resin becomes more susceptible to oxidative degradation as a residence time thereof at high temperature increases. The contaminant resulted from the oxidative degradation and remaining in the molded product is referred to as burn, sunspot, yellow, stone, fisheye, gel, or the like, and is a major cause for molding failure.

Recently, as a countermeasure therefor, a resin molding apparatus with the structure of sealing the inside of the resin molding apparatus with nitrogen or the structure of forcibly exhausting the air containing oxygen has been developed and utilized.

However, it is impossible to completely remove oxygen in the resin molding apparatus and thus to completely prevent the molding failure. Further, if the residence time of the resin in the high-temperature melting state is shortened, a non-molten resin is extruded into a molded product as it is to cause the molding failure. Therefore, it is very difficult to find the optimal molding condition.

Therefore, an object of the present invention is to provide a resin molding apparatus capable of producing a plastic member, a plastic film, and a plastic fiber which do not emit harmful organic molecules and a resin molding process.

An another object of the present invention is to provide a resin molding apparatus which is small in size, light in weight, and low in electric power consumption.

### Means for Solving the Problem

According to an aspect of this invention, there is provided a resin molding apparatus for molding a molten resin, comprising means for inhibiting a polymeric material from forming a low-molecular organic substance due to decomposition or dissociation of the polymeric material. Furthermore, there is also provided a resin molding apparatus for molding a molten resin, comprising means for inhibiting the polymeric material from forming a low-molecular organic substance due to decomposition or dissociation of the polymeric material and lowering viscosity of the molten resin, wherein an injection pressure or an extrusion pressure for molding a resin is reduced.

The resin molding apparatus is characterized by comprising means for inhibiting decomposition or dissociation due to oxidation. Preferably, the means comprises means for adjusting a concentration of oxygen in an atmosphere, with which a raw material of the molten resin or the molten resin is in contact, to 10 ppm or lower. Preferably, the means comprises means for adjusting a concentration of moisture (H₂O) in an atmosphere, with which a raw material of the molten resin or the molten resin is in contact, to 10 ppm or lower.

The resin may comprise at least one resin selected from the group consisting of an acrylic-based resin, a silicone-based resin, a fluorine-based resin, a polyimide-based resin, a polyolefin-based resin, an alicyclic olefin-based resin, an epoxy-based resin, a hydrocarbon-based resin, and a fluorocarbon-based resin.

Furthermore, this invention is also characterized in that the means comprises means for adjusting a concentration of at least one of oxygen and moisture in an atmosphere, with which the raw material of the molten resin or the molten resin is in contact, to 1 ppm or lower, and that the resin comprises a hydrocarbon-based resin. In this case, it is further preferable that the concentration of at least one of oxygen and moisture is 0.1 ppm or lower.

Alternatively, this invention is also characterized in that the means comprises means for adjusting a concentration of at least one of oxygen and moisture in an atmosphere, with which the raw material of the molten resin or the molten resin is in contact, to 10 ppm or lower, and that the resin comprises a fluorocarbon-based resin. It is further preferable that the concentration of at least one of oxygen and moisture is 1 ppm or lower. The fluorocarbon-based resin may comprise at least one of tetrafluoroethylene, hexafluoropropene, tetrafluoropropyne, hexafluorocyclobutene, hexafluoro-1,3-butadiene, hexafluoro-1-butyne, hexafluoro-2-butyne, octafluorocyclobutane, octafluorocyclopentene, octafluoro-1,3-pentadiene, octafluoro-1,4-pentadiene, octafluoro-1-pentyne, octafluoro-2-pentyne, and hexafluoro benzene.

As another feature of this invention, a granular resin raw material supplied as a raw material for a molten resin is brought into contact with an inert gas heated at a temperature lower than a temperature at which the resin raw material melts. Alternatively, an atmosphere of at least one of a portion where a raw material of the molten resin melts, a portion where the molten resin moves to an injection part or an extrusion part, a portion where the resin is extruded from a long and thin slit or a small hole, and a mold injection molding portion is converted to a high purity inert gas atmosphere.

This invention is also characterized in that the means comprises a material having a low catalytic effect on the molten resin, the material covering at least a part of a surface with which the molten resin is in contact.

Furthermore, it is preferable that the material contains Al or Cr as at least one of main components, and the resin comprises a hydrocarbon-based resin. It is further preferable that the material comprises trivalent chromium, aluminum oxide, or chromium oxide.

Alternatively, the material may contain Ni as at least one of main components, and the resin may comprise a fluorocarbon-based resin. It is preferable that the material comprises at least one of plated Ni, Ni—P, Ni—B, and Ni—W—P.

It is preferable that the material covers a surface of at least one of a screw, a cylinder, a housing, a nozzle, a blow-off slit, a blow-off hole, a mold, a die, and a roll.

For example, the resin may comprise a resin for an optically molded product and may be a nonpolar polyolefin-based resin or a cycloolefin resin.

A resin molding apparatus according to this invention can perform injection molding, film extrusion molding, or fiber extrusion molding. In the injection molding, the resin molding apparatus preferably has a plurality of pouring/injection points. Preferably, mold driving means includes temperature controlling means. When the temperature controlling means is water, hydrogenation water is preferable. In order to remove static electricity of a resin-molded product, soft X-ray irradiation means is preferably provided.

In another aspect of this invention, there is provided a resin molding process, comprising a first step of melting a resin, and a second step of molding the molten resin by injection or extrusion, wherein at least one of the first step and the second step is performed while a polymeric material is inhibited from forming a low-molecular organic substance due to decomposition or dissociation of the polymeric material. Furthermore, there is provided a resin molding process, comprising a first step of melting a resin, and a second step of molding the molten resin by injection or extrusion, wherein at least one of the first step and the second step is performed while a polymeric material is inhibited from forming a low-molecular organic substance due to decomposition or dissociation of the polymeric material, to thereby increase a temperature of the molten resin and lower a viscosity of the molten resin, and an injection pressure or an extrusion pressure for molding a resin is reduced.

At least one of the first step and the second step may be performed while a polymeric material is inhibited from decomposing or dissociating due to oxidation. Alternatively, at least one of the first step and the second step is performed while a concentration of oxygen in an atmosphere may be adjusted to 10 ppm or lower, the atmosphere being contacted by a raw material of the molten resin or the molten resin. Furthermore, at least one of the first step and the second step may be performed while a concentration of moisture in an atmosphere is adjusted to 10 ppm or lower, the atmosphere being contacted by a raw material of the molten resin or the molten resin. Alternatively, when at least one of the first step and the second step is performed, at least a part of a surface with which the molten resin is in contact is covered with a material having a low catalytic effect on the molten resin.

This invention further provides a production process for a resin-molded product, wherein the resin-molded product is molded using the resin molding process.

### EFFECT OF THE INVENTION

The present invention provides a resin molding apparatus capable of producing plastic members, plastic films, and plastic fibers which do not emit harmful organic substances and a resin molding process. Further, according to the present invention, the resin molding apparatus can be reduced in size, weight, and electric power consumption. As in the present invention, by employing means for inhibiting oxidative decomposition and catalytic decomposition, a molten plastic does not decompose and dissociate until a temperature becomes high, so a molten plastic having an extremely low viscosity is produced. Therefore, film extruding, tubular fiber extruding, and mold injection molding can be performed at a very low extrusion pressure and a very low injection pressure, whereby the size and the weight of a molding apparatus can be reduced.

### BRIEF DESCRIPTION OF THE DRAWINGS

FIG. 1 is a cross sectional view of an injection molding apparatus, which is an example of the present invention.

FIG. 2 is a graph showing the temperature dependence of low-molecular released gas amount when the low-molecular released gas, which is generated on various metallic material surfaces at the time of thermal decomposition of cycloolefin polymer, is measured using atmospheric pressure ionization mass spectrometry (APIMS).

FIG. 3 is a graph showing the result of the temperature dependence of low-molecular released gas when the low-molecular released gas, which is generated at the time of thermal decomposition of cycloolefin polymer under various oxygen concentration atmospheres, is measured using Fourier transform infrared spectroscopy.

FIG. 4 is a graph showing the temperature dependence of low-molecular released gas amount when the low-molecular released gas, which is generated at the time of thermal decomposition of a PFA resin, is measured using Fourier transform infrared spectroscopy.

### DESCRIPTION OF SYMBOLS

4 screw
5 cylinder
6 nozzle
7 mold
8 injection molding apparatus
9 hopper

### BEST MODE FOR EMBODYING THE INVENTION

Hereinafter, description will be given of a constitution and operation according to the present invention.

First, one of the requirements the present invention must include is to inhibit oxidative degradation and dissociation of a polymeric material in such a manner that the polymeric material may not form a low-molecular organic substance due to the decomposition and dissociation thereof. The inventors of the present invention found that the oxidative decomposition and dissociation can be inhibited and a heating temperature can be increased by adjusting each of the concentrations of O₂ and H₂O to 1 ppm or lower, and preferably 0.1 ppm or lower with respect to hydrocarbon-based plastics and adjusting each of the concentrations of O₂ and H₂O to 10 ppm or lower, and preferably 1 ppm or lower with respect to fluorocarbon-based plastics (PTFE, PFA, PVDF, etc.). Based on this finding in the present invention, in order to remove moisture (H₂O) and oxygen (O₂) adsorbed to the surface of or occluded in a granular raw material, a high purity inert gas, for example, N₂ gas is applied to the raw material at as high a temperature as possible in the range where the raw material does not decompose, before the raw material is supplied to a hopper. Further, the atmosphere of each of a hopper to which a raw material is supplied; a portion where the temperature of a plastic raw material is increased, whereby a liquid plastic having a low viscosity is produced; an extruding/injection portion; a portion where a film or a fiber from a thin and long slit or a hole having a small diameter is extruded; and a mold injection molding part is also replaced with a high purity inert gas, for example, N₂ atmosphere. Thus, the oxidative degradation and dissociation are inhibited.

According to one of the findings of the inventors of the present invention, a molten plastic is sensitive to catalytic effects on various surfaces with which the molten plastic is in contact. For example, it was found that a hydrocarbon-based resin is susceptible to an Ni surface and a stainless steel surface, and is stable to A1₂O₃ and Cr₂O₃, and a fluorocarbon-based resin is susceptible to stainless steel or A1₂O₃, and is stable to Ni (NiF₂). Considering the actual production, in the case of a hydrocarbon-based resin, a surface with which a molten plastic is in contact is preferably an Al coated surface, a Cr coated surface (e.g., a surface on which an about 0.2 μm thick trivalent Cr is plated on a 1 μm thick Ni—P base), an Al₂O₃ surface, and a Cr₂O₃ surface. In the case of a fluorocarbon-based resin, an Ni coated surface, an Ni—P plated surface, an Ni—B plated surface, and an Ni—W—P plated surface are recommended.

In other words, one of, a plurality of, or all of screw surfaces, a housing surface, a blow-off slit surface, and a blow-off hole surface, and a mold surface must be plated or coated as described above.

By performing the above-described treatment taking the oxidative degradation and catalytic effects into consideration, a molten plastic does not decompose and dissociate until a temperature becomes high, whereby a molten plastic having an extremely low viscosity is produced. Cycloolefin, which is a hydrocarbon-based resin, does not decompose and dissociate until a temperature reaches 400° C., and PTFE and PFA, which are fluorocarbon-based resins, do not decompose and dissociate until a temperature reaches 380° C. Therefore, the film extruding molding, the tubular fiber extruding molding, and the mold injection molding can be performed at a very low extrusion pressure or a very low injection pressure.

### Examples

Examples of the present invention will be described with reference to an example of a mold injection molding apparatus.

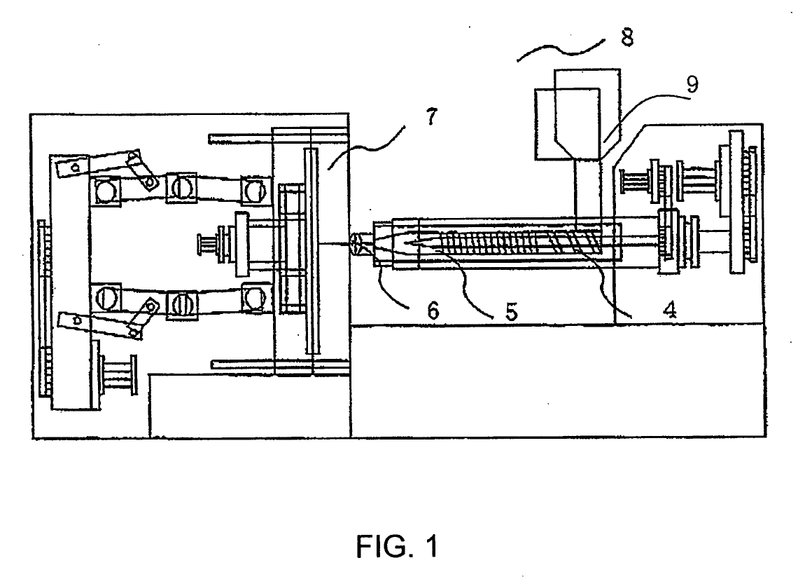

FIG. 1 is a cross sectional view illustrating an example of an injection molding apparatus of the present invention. A resin molding apparatus (injection molding apparatus) 8 according to one embodiment of the present invention illustrated in FIG. 1 is provided with a cylinder 5, a screw 4, a nozzle 6, and a mold 7. In the resin molding apparatus, a resin pellet is supplied to the cylinder 5 from a hopper 9.

Of those, since the screw 4, the cylinder 5, the nozzle 6, and the mold 7 are in contact with a molten resin, each of the surfaces thereof, which are in contact with the molten resin, is covered with a material mentioned later. Here, description is given taking an example of the injection molding apparatus, but the present invention is also applicable to an extruding molding apparatus and a kneader besides the injection molding apparatus.

The present invention provides a small, light-weight, and ultra low electric power consumption apparatus by reducing an injection pressure as much as possible. The essential points (constitutional requirements) of this invention are as described below:

(1) The temperature of a molten plastic is increased as high as possible. To that end, in the case where melting and molding are performed in an N₂ atmosphere in which O₂ and H₂O are blocked, and cycloolefin (typical hydrocarbon-based plastic) is used, the temperature of a molten plastic can be increased up to 370 to 380° C. by covering each of a molten resin-contacting surfaces with a Cr₂O₃ coat using a Cr plating base. Conventionally, the temperature of a molten plastic can be increased to at most 280° C. or lower and the viscosity is 10 times or higher than that the present invention provides. In the case of PFA (typical fluorocarbon-based plastic), the temperature of a molten plastic can be increased up to 360 to 370° C. by plating the surface of a member with Ni. Conventionally, the temperature is increased to at most 290° C. or lower.

(2) Trivalent Chromium Plating (a Resin-Melting Unit of a Molding Apparatus and an Injection Molding Mold):

In molding a hydrocarbon-based resin, in order to inhibit decomposition of the resin, a chromium-plated surface is preferable. This is because the chromium-plated surface is naturally oxidized to form a chromium oxide film. It is preferable to use trivalent chromium so that the chromium oxide film is formed of Cr₂O₃. In common chromium plating, a hexavalent chromium is used. However, the hexavalent chromium is not preferable because an oxide film is formed of CrO₃ when the hexavalent chromium is used. In addition, the hexavalent chromium is not preferable because it is harmful. In general, chromium is preferably plated so as to have a film thickness of about 0.2 μm. A mold surface on which fine pitches are formed is obtained by forming a fine shape on a plated surface using a diamond cutting technique or the like. However, when chromium plating is applied to the mold surface, the surface cannot be machined so as cutting due to the high surface hardness. Thus, it is preferable to apply chromium plating to the mold surface after the surface is subjected to easy-to-process plating treatment such as nickel plating or Ni—P plating as a base and machined.

(3) The number of pouring/injection points is increased to as large number as possible using a multipoint injection.

When a protruding navel may be formed on the side of a resin-molded product, the pouring/injection points, for example, 12 points calculated by 3×4, are formed on the side of the mold in a matrix shape. When the formation of a protruding navel on the side of the resin-molded product is not preferable, resin pouring is performed from a side surface. Also in this case, a plurality of pouring/injection points are formed on the side whose surface is longer. Conventionally, the number of the injection point was one; pouring was performed at 280° C.; and an injection pressure of as high as 1,500 t was required. In contrast, in the present invention, when the pouring temperature is 380° C. and 12 injection points are formed, injection can be performed at an injection pressure of as low as 100 kg or lower. Thus, a clamping pressure and a driving pressure of a mold can be sharply reduced.

(4) When the injection pressure can be reduced, a pressure applied to a mold is sharply reduced. Therefore, an inhibitory mechanism and the like of a mold can be made very simple and very small, whereby heat capacity of the entire mold driving unit can be dramatically reduced. Provided in a mold driving jig is a temperature controller capable of changing the temperature of the mold surface by periodically repeating a high temperature cycle of 150 to 160° C. and a low temperature cycle of 25 to 40° C. When pouring/injecting a plastic, a molten plastic is poured while adjusting a mold temperature to 150 to 160° C. The poured plastic flows at an extremely high rate because the mold surface has a high temperature, and a very fine configuration of the mold is minutely transferred. Since the mold surface has a high temperature, even if multipoint injection is performed, the formation of a weld line at a joint is not at all observed. After the injection process is performed, the temperature is lowered to 25 to 40° C., and then a molded product is taken out. To that end, a coolant for controlling the temperature is poured in the mold driving jig for circulation. When using cooling water as the coolant, hydrogenation water which does not cause rusting of metal and which prevents propagation of bacteria is used. As the hydrogenation water, it is preferable to use pure water containing hydrogen in an amount of 0.1 to 1.6 ppm, and preferably 0.2 to 1.0 ppm (saturation solubility of hydrogen in water at room temperature: 1.6 ppm). When hydrogenation water is not used, a molding apparatus is soon rusted.

By following the above-described procedure, conventionally-employed remarkably high injection pressures, such as 1,000 t and 2,000 t are unnecessary. An injection pressure as low as 10 kg/square centimeter or lower is sufficient. Consequently, the apparatus can be miniaturized, and a 1/10 to 1/100 weight of a conventional apparatus is sufficient.

(5) Pouring a Resin into a Plurality of Molds (Injection Molding Apparatus):

According to the technique of the present invention, the viscosity of a resin is sharply reduced. This enables to flow the resin using a piping, and to switch a flow path via a valve. Thus, the resin can be poured into a plurality of molds. By the use of a plurality of molds, the productivity is dramatically improved.

(6) Blowing an Inert Gas in Releasing a Mold (Application to an Injection Molding Mold):

When a resin is injected into a mold in an injection molding process, the transferability of the resin to the mold surface is improved when the viscosity of the molten resin decreases. For example, in the case of an product such as a Fresnel lens or an optical disc having a fine pitch (groove) structure, the resin is densely charged in the pitch. Consequently, adhesion with the mold surface is increased, whereby a molded product is not easily released from the mold. The reason why the molded product becomes hard to release from the mold is that a vacuum state is created between the mold and the molded product due to tight adhesion therebetween when the molded product is released from the mold. By introducing an inert gas into a mold pitch when the molded product is released from the mold, the vacuum state is eliminated, whereby the molded product is likely to release from the mold. The inert gas is introduced from a portion of the mold which does not adversely influence on the molded product quality.

(7) Adjustment of Thickness of an Extrusion Molding Apparatus by a Piezoelectric Material (Extrusion Molding Apparatus):

In general, each thickness of a film, a pipe, a fiber, etc. in an extrusion molding apparatus is adjusted by controlling a molten resin temperature. However, the thickness cannot be precisely adjusted by such a process. Then, it is preferable to use a piezoelectric material for adjusting the thickness in an extrusion molding apparatus. The piezoelectric material is placed at a die portion from which a molten resin is extruded, and used while adjusting the number of the piezoelectric material, if necessary.

(8) Static electricity is developed in both the injection molding and the film/fiber extrusion molding.

In general, an ionizer using a discharge electrode is used for removing static electricity. However, when the ionizer is used in the atmosphere, O₃ (ozone) is generated, whereby a plastic polymer decomposes and dissociates to thereby reduce the molecule weight. Therefore, the ionizer which generates O₃ must not be used. Thus, static electricity may be removed by irradiating the air with soft X-ray having a wavelength of about 1 to 2 Å using a soft X-ray generating tube while not generating O₃. Gas molecules are extremely efficiently ionized even in an inert N₂ atmosphere, thereby efficiently removing static electricity.

(9) In the currently-used injection molding apparatus, a strong injection pressure is obtained by slowly retreating the screw 4 to the right side once, and then rapidly projecting the screw 4 to the left side when a resin is in a molten state around the tip portion of the screw 4. This is because the viscosity of the molten resin is high. However, according to the present invention, since the temperature can be increased while inhibiting decomposition and dissociation of the molten resin, the viscosity of the molten resin is very low. By providing a plurality of (e.g., 4 to 6 pieces) mold units illustrated in FIG. 1 in parallel; and continuously rotating the screw to thereby continuously supplying the molten resin, a continuous molding process using molds by which the molten resin is successively supplied to the plurality of molds by a valve operation is achieved. When a processed resin product is taken out from the first mold, and the first mold is prepared to receive a molten resin, the following molten resin is poured by a valve operation. In the molding process, a molten resin flows into the plurality of mold units provided in parallel one after another, and thus a molding using molds is successively performed. Thus, a novel resin molding can be obtained.

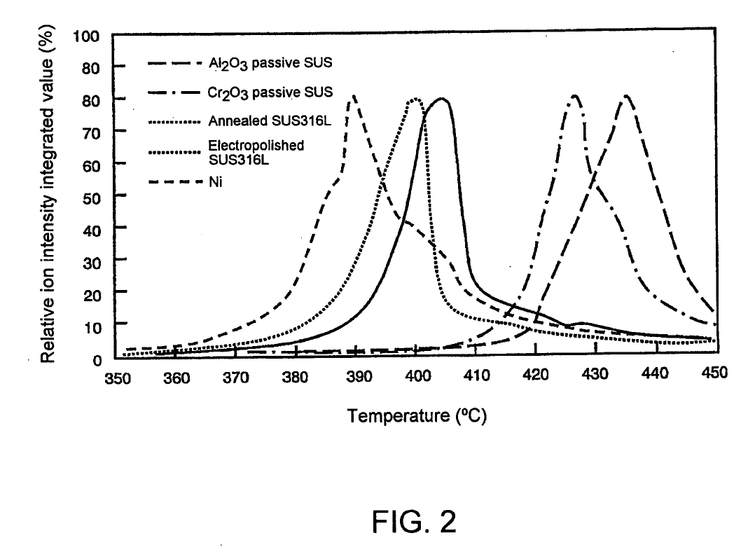

(10) FIG. 2 illustrates the temperature dependence of low-molecular released gas amount when the low-molecular released gas which is generated on various metallic material surfaces at the time of thermal decomposition of cycloolefin polymer is measured using atmospheric pressure ionization mass spectrometry (APIMS). The axis of abscissa represents the surface temperature of metal and the axis of ordinate represents a total intensity of a mass spectrum derived from a low-molecular released gas. FIG. 2 shows that the Ni surface generates a released gas at the lowest temperature. It can be confirmed that the generation of a low-molecular released gas component on the Ni surface due to thermal decomposition of resin starts to be detected by APIMS at about 350° C. Following the Ni surface, a temperature at which the generation of a low-molecular released gas component due to thermal decomposition of resin is detected becomes higher as described below: the generation of a low-molecular released gas component is detected at 360° C. on the electropolished (EP) surface of austenitic stainless steel SUS316L, at 370° C. on the annealed surface (BA) of SUS316L, and at 400° C. on the surface of ferrite stainless steel FS9 subjected to a Cr₂O₃ passive treatment of 200 Å. Among the selected materials in this embodiment, it is on the surface of austenitic stainless steel HR31 subjected to A1₂O₃ passive treatment of 500 Å that the generation of released gas due to decomposition and dissociation is not detected until a temperature reaches a higher temperature. It was revealed that the surface thus treated showed an effect of inhibiting thermal decomposition of a cycloolefin polymer up to 410° C. Description is given taking, for example, a cycloolefin polymer injection-based, i.e., hydrocarbon-based injection-based, molding apparatus (e.g., FIG. 1). The decomposition and dissociation of plastics due to a catalytic effect can be inhibited until a temperature reaches 410° C. by using metallic materials which were subjected to A1₂O₃ passive treatment as metallic materials constituting the cylinder 5, the screw 4, the nozzle 6, and the mold 7. Therefore, a molding process by injection molding can be employed at a higher temperature. Consequently, since a molten state having a lower viscosity is obtained, molding can be performed at very slight clamping pressure and injection pressure. In other words, the injection molding apparatus can be reduced in size and weight. The function is also applicable to a film extrusion molding apparatus and a tubular fiber extrusion molding apparatus for a hydrocarbon-based resin such as a cycloolefin polymer.

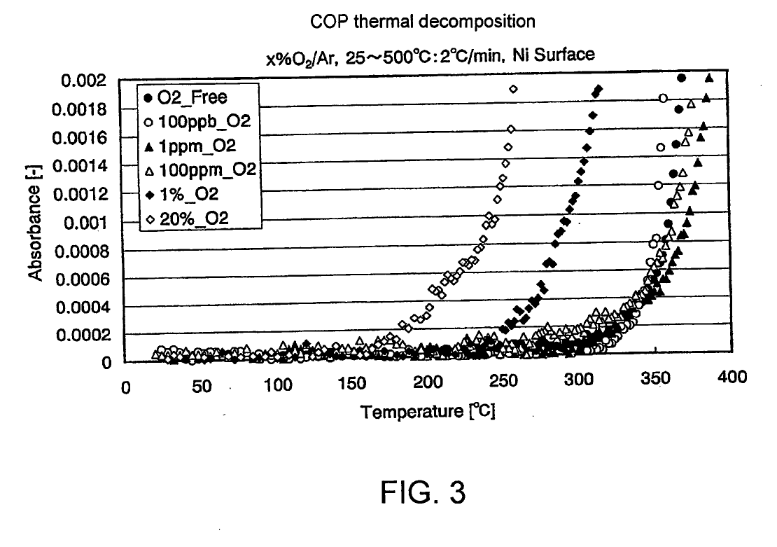

FIG. 3 illustrates the result of the temperature dependence of a low-molecular released gas when the low-molecular released gas which is generated at the time of thermal decomposition of a cycloolefin polymer under various oxygen concentration atmospheres is measured using Fourier transform infrared spectroscopy. The surface of a material with which a cycloolefin polymer is in contact when the measurement is performed on an Ni-metal surface, on the assumption that Ni plating is currently applied on the surface of a mold. The axis of abscissa represents the surface temperature of Ni and the axis of ordinate represents the intensity of infrared absorbance originating from a low-molecular released gas. FIG. 3 reveals that when the concentration of oxygen which coexists in a vapor phase is higher, a degradation starting temperatures is lower. Under a 20% O₂ atmosphere, the generation of a low-molecular released gas due to thermal decomposition of a cycloolefin polymer starts to be observed at 150° C. Under an atmosphere in which oxygen does not coexist, the generation of a released gas starts to be observed around 300° C. The fact confirmed that the difference in the temperature at which the generation of a released gas starts to be observed between the atmosphere in which oxygen coexists and the atmosphere in which oxygen does not coexist was as high as 150° C. When the coexistent oxygen concentration in a vapor phase becomes 1 ppm or lower, the decomposition and dissociation due to oxidative degradation can be inhibited. The decomposition of a material is rate-controlled by thermal decomposition and dissociation due to catalytic action originating from the Ni material. More specifically, the amount of a low-molecular monomer due to oxidative decomposition of a resin can be reduced by adjusting to 1 ppm or lower the oxygen concentration under an atmosphere with which a molten resin is in contact at the time of injection molding. High purity nitrogen adjusted to have the concentration of 1 ppm or lower of oxygen and moisture is supplied to the inside of the hopper 9 in FIG. 1, which is charged with raw material resin pellets; heating is performed at a temperature lower than a temperature at which the raw material resin melts; a function for substantially removing the oxygen and the moisture contained in the raw material resin is provided in the molding apparatus; and an atmosphere of each of the cylinder 5, the screw 4, the nozzle 6, and the mold 7 provided inside the injection molding apparatus in which the molten resin exists is converted to a high purity nitrogen atmosphere; thereby reducing the amount of a low molecular weight resin generated by oxidative decomposition. It is possible to mold a high functional resin material in which out gas into a vapor phase of a low molecular weight monomer having a high vapor pressure from the resin material and the elution into a liquid phase are substantially inhibited. The function is also applicable to a film extrusion molding apparatus and a tubular fiber extrusion molding apparatus for a hydrocarbon-based resin.

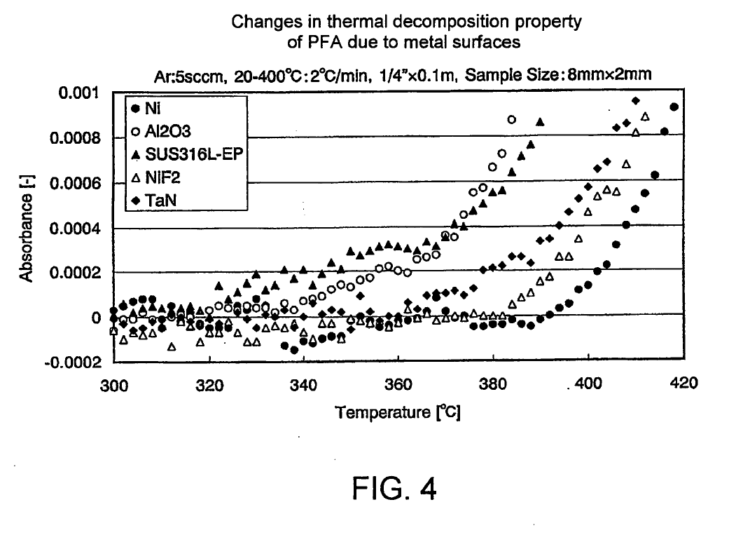

FIG. 4 illustrates the temperature dependence of low-molecular released gas amount when the low-molecular released gas, which is generated on various metallic material surfaces at the time of thermal decomposition of a PFA resin, which is one of fluorine-based resins, is measured using Fourier transform infrared spectroscopy. The axis of abscissa represents the surface temperature of metal, and the axis of ordinate represents the intensity of infrared absorbance originating from a low-molecular released gas. It is revealed that an Ni surface is a metallic material surface which shows an effect of inhibiting the generation of a released gas due to thermal decomposition of a resin up to high temperatures, in contrast to the thermal decomposition of a hydrocarbon-based resin. It is revealed that the release of a C₂F₄ gas which is generated due to decomposition of PFA can be inhibited up to about 380° C. to 390° C. Then, it is revealed that the temperature at which the release of a C₂F₄ gas can be inhibited is lowered in the following order; an NiF₂ surface which is obtained by fluoriding an Ni surface>a TN surface>a stainless steel surface subjected to Al₂O₃ passive treatment>an electropolished surface of SUS316L. This result is similarly observed in PTFE, and thus an equivalent result may be possibly obtained in fluororesin materials. Take, for example, a resin material injection molding apparatus such as a apparatus shown in FIG. 1. The decomposition and dissociation of PFA resin due to a catalytic effect can be inhibited until a temperature reaches 390° C. by using Ni-based metallic materials for metallic materials constituting the cylinder 5, the screw 4, the nozzle 6, and the mold 7. Therefore, a molding process by injection molding can be employed at a higher temperature. Consequently, since a molten state having low viscosity is obtained, molding can be performed at very slight clamping pressure and injection pressure. In other words, the injection molding apparatus can be reduced in size and weight. The function is also applicable to a film extrusion molding apparatus and a tubular fiber extrusion molding apparatus for a PFA resin.

### INDUSTRIAL APPLICABILITY

The present invention is also applicable to molding of a film made of a fluororesin, PFA, a fluorocarbon-based resin, etc. The molding apparatus of the present invention is effective for any molding apparatuses used for molding a resin. The molding apparatus used for molding a resin refers to a resin molding apparatus such as an injection molding apparatus, a transfer molding apparatus, an extrusion molding apparatus, a blow molding apparatus, a compression molding apparatus, a vacuum molding apparatus, etc. Further, the present invention is applicable not only to the molding apparatus for obtaining a molded product but also an extrusion molding apparatus, a melt kneader, a roll kneader, etc, for adding a compounding agent or creating a resin pellet.

1. A resin molding apparatus for molding a molten resin, comprising means for inhibiting a polymeric material from forming a low-molecular organic substance due to decomposition or dissociation of the polymeric material.

2. A resin molding apparatus according to claim 1, wherein the inhibiting means lowers viscosity of the molten resin so that an injection pressure or an extrusion pressure for molding a resin is reduced.

3. A resin molding apparatus according to claim 1, wherein the means comprises means for inhibiting decomposition or dissociation due to oxidation.

4. A resin molding apparatus according to claim 3, wherein the means comprises means for adjusting a concentration of oxygen in an atmosphere, with which a raw material of the molten resin or the molten resin is in contact, to 10 ppm or lower.

5. A resin molding apparatus according to claim 4, wherein the means comprises means for adjusting a concentration of moisture (H₂O) in an atmosphere, with which a raw material of the molten resin or the molten resin is in contact, to 10 ppm or lower.

6. A resin molding apparatus according to claim 1, wherein the resin comprises at least one resin selected from the group consisting of an acrylic-based resin, a silicone-based resin, a fluorine-based resin, a polyimide-based resin, a polyolefin-based resin, an alicyclic olefin-based resin, an epoxy-based resin, a hydrocarbon-based resin, and a fluorocarbon-based resin.

7. A resin molding apparatus according to claim 3, wherein
the means comprises means for adjusting a concentration of at least one of oxygen and moisture in an atmosphere, with which the raw material of the molten resin or the molten resin is in contact, to 1 ppm or lower; and
the resin comprises a hydrocarbon-based resin.

8. A resin molding apparatus according to claim 7, wherein the concentration of at least one of oxygen and moisture is 0.1 ppm or lower.

9. A resin molding apparatus according to claim 3, wherein
the means comprises means for adjusting a concentration of at least one of oxygen and moisture in an atmosphere, with which the raw material of the molten resin or the molten resin is in contact, to 10 ppm or lower; and
the resin comprises a fluorocarbon-based resin.

10. A resin molding apparatus according to claim 9, wherein the concentration of at least one of oxygen and moisture is 1 ppm or lower.

11. A resin molding apparatus according to claim 9, wherein the fluorocarbon-based resin comprises at least one of tetrafluoroethylene, hexafluoropropene, tetrafluoropropyne, hexafluorocyclobutene, hexafluoro-1,3-butadiene, hexafluoro-1-butyne, hexafluoro-2-butyne, octafluorocyclobutane, octafluorocyclopentene, octafluoro-1,3-pentadiene, octafluoro-1,4-pentadiene, octafluoro-1-pentyne, octafluoro-2-pentyne, and hexafluoro benzene.

12. A resin molding apparatus according to claim 1, wherein a granular resin raw material supplied as a raw material for a molten resin is brought into contact with an inert gas heated at a temperature lower than a temperature at which the resin raw material melts.

13. A resin molding apparatus according to claim 1, an atmosphere of at least one of a portion where a raw material of the molten resin melts; a portion where the molten resin moves to an injection part or an extrusion part; a portion where the resin is extruded from a long and thin slit or a small hole; and a mold injection molding portion is converted to a high purity inert gas atmosphere.

14. A resin molding apparatus according to claim 2, wherein the means comprises a material having a low catalytic effect on the molten resin, the material covering at least a part of a surface with which the molten resin is in contact.

15. A resin molding apparatus according to claim 14, wherein
the material contains Al or Cr as at least one of main components; and
the resin comprises a hydrocarbon-based resin.

16. A resin molding apparatus according to claim 15, wherein the material comprises aluminum oxide or chromium oxide.

17. A resin molding apparatus according to claim 14, wherein
the material contains Ni as at least one of main components; and
the resin comprises a fluorocarbon-based resin.

18. A resin molding apparatus according to claim 17, wherein the material comprises at least one of plated Ni, Ni—P, Ni—B, and Ni—W—P.

19. A resin molding apparatus according to claim 14, wherein the material covers a surface of at least one of a screw, a cylinder, a housing, a nozzle, a blow-off slit, a blow-off hole, a mold, a die, and a roll.

20. A resin molding apparatus according to claim 1, wherein the resin comprises a resin for an optically molded product.

21. A resin molding apparatus according to claim 20, wherein the resin comprises a nonpolar polyolefin-based resin or a cycloolefin resin.

22. A resin molding apparatus according to claim 1, wherein injection molding, film extrusion molding, or fiber extrusion molding is performed.

23. A resin molding apparatus according to claim 22, wherein the resin molding apparatus performs injection molding and has a plurality of pouring/injection points.

24. A resin molding apparatus according to claim 22, wherein the resin molding apparatus performs injection molding and comprises mold driving means and temperature controlling means provided at the mold driving means.

25. A resin molding apparatus according to claim 22, wherein the resin molding apparatus performs injection molding and the temperature controlling means comprises hydrogenation water.

26. A resin molding apparatus according to claim 22, wherein the resin molding apparatus performs injection molding and comprises soft X-ray irradiation means for removing static electricity of a resin-molded product which is released from the mold.

27. A resin molding apparatus according to claim 22, wherein the molding apparatus performs film extrusion molding or fiber extrusion molding, and comprises soft X-ray irradiation means for removing static electricity of a molded product.

28. A resin molding process, comprising:
a first step of melting a resin; and
a second step of molding the molten resin by injection or extrusion, wherein
at least one of the first step and the second step is performed while a polymeric material is inhibited from forming a low-molecular organic substance due to decomposition or dissociation of the polymeric material.

29. A resin molding process according to claim 28, wherein:
at least one of the first step and the second step is performed while a polymeric material is inhibited from forming a low-molecular organic substance due to decomposition or dissociation of the polymeric material, to thereby increase a temperature of the molten resin and lower a viscosity of the molten resin; and
an injection pressure or an extrusion pressure for molding a resin is reduced.

30. A resin molding process according to claim 28, wherein at least one of the first step and the second step is performed while a polymeric material is inhibited from decomposing or dissociating due to oxidation.

31. A resin molding process according to claim 30, wherein
at least one of the first step and the second step is performed while a concentration of oxygen in an atmosphere is adjusted to 10 ppm or lower, the atmosphere being contacted by a raw material of the molten resin or the molten resin.

32. A resin molding process according to claim 31, wherein
at least one of the first step and the second step is performed while a concentration of moisture in an atmosphere is adjusted to 10 ppm or lower, the atmosphere being contacted by a raw material of the molten resin or the molten resin.

33. A resin molding process according to claim 28, wherein the resin comprises at least one resin selected from the group consisting of an acrylic-based resin, a silicone-based resin, a fluorine-based resin, a polyimide-based resin, a polyolefin-based resin, an alicyclic olefin-based resin, an epoxy-based resin, a hydrocarbon-based resin, and a fluorocarbon-based resin.

34. A resin molding process according to claim 30, wherein
at least one of the first step and the second step is performed while a concentration of at least one of oxygen and moisture in an atmosphere is adjusted to 1 ppm or lower, the atmosphere being contacted by a raw material of the molten resin or the molten resin; and
the resin comprises a hydrocarbon-based resin.

35. A resin molding process according to claim 34, wherein the concentration of at least one of oxygen and moisture is 0.1 ppm or lower.

36. A resin molding process according to claim 30, wherein at least one of the first step and the second step is performed while a concentration of at least one of oxygen and moisture in an atmosphere is adjusted to 10 ppm or lower, the atmosphere being contacted by a raw material of the molten resin or the molten resin; and
the resin comprises a fluorocarbon-based resin.

37. A resin molding process according to claim 36, wherein the concentration of at least one of oxygen and moisture is 1 ppm or lower.

38. A resin molding process according to claim 28, wherein a granular resin raw material supplied as a raw material for a molten resin is brought into contact with an inert gas heated at a temperature lower than a temperature at which the resin raw material melts.

39. A resin molding process according to claim 28, wherein at least one of the first step and the second step is performed in a high purity inert gas atmosphere.

40. A resin molding process according to claim 29, wherein when at least one of the first step and the second step is performed, at least a part of a surface with which the molten resin is in contact is covered with a material having a low catalytic effect on the molten resin.

41. A resin molding process according to claim 40, wherein the material contains Al or Cr as at least one of main components; and
the resin comprises a hydrocarbon-based resin.

42. A resin molding process according to claim 41, wherein the material comprises aluminum oxide or chromium oxide.

43. A resin molding process according to claim 40, wherein
the material contains Ni as at least one of main components; and
the resin comprises a fluorocarbon-based resin.

44. A resin molding process according to claim 43, wherein the material comprises at least one of plated Ni, Ni—P, Ni—B, and Ni—W—P.

45. A resin molding process according to claim 28, wherein injection molding, film extrusion molding, or fiber extrusion molding is performed in the second step.

46. A resin molding process according to claim 28, wherein the second step comprises a soft X-ray irradiation for removing static electricity in a molded product.

47. A production process for a resin-molded product, wherein the resin-molded product is molded using the resin molding process according to claim 28.
